(19) United States
(12) Patent Application Publication
(10) Pub. No.: US 2026/0235057 A1
(43) Pub. Date: Aug. 13, 2026

(54) Internal Combustion Engine for a Motor Vehicle

(71) Applicant: Bayerische Motoren Werke Aktiengesellschaft, Muenchen (DE)

(72) Inventors: Joerg Stroese, Eglharting (DE); Christian Absmeier, Waakirchen (DE); Stefan Doemling, Diedorf (DE); Petar Kis, Markt Indersdorf (DE); Frank Zimmermann, Muenchen (DE)

(21) Appl. No.: 19/474,973

(22) PCT Filed: Mar. 21, 2024
(86) PCT No.: PCT/EP2024/057594

§ 371 Date: Oct. 13, 2025

(30) Foreign Application Priority Data
Apr. 18, 2023 (DE) 10 2023 109 653.2

(51) Int. Cl. F01M 13/02; B60K 15/035; F01M 13/00; F01M 13/04

(52) U.S. Cl. CPC F01M 13/021; B60K 15/035; F01M 13/04; F01M 2013/0044; F01M 2013/005; F01M 2013/026

(57) ABSTRACT

An internal combustion engine for a motor vehicle includes a crankcase and an inlet tract through which air can flow. The crankcase includes a throttle flap arranged in the inlet tract and configured to adjust a volume of the air supplied to at least one combustion chamber of the internal combustion engine. A crankcase ventilation means includes a suction jet pump to which at least a part of the air from the inlet tract is supplied to ventilate the crankcase. Gas is sucked out of the crankcase as a suction medium by means of the suction jet pump by using the air supplied from the suction jet pump as a propellant for the suction jet pump. At least the part of the air is branched off from the inlet tract as the propellant at a supply point arranged downstream of the throttle flap.

### CROSS-REFERENCE TO RELATED APPLICATIONS

The present application is the U.S. national phase of PCT Application PCT/EP2024/057594 filed on Mar. 21, 2024, which claims priority of German patent application No. 10 2023 109 653.2 filed on Apr. 18, 2023, the entire contents of which are incorporated herein by reference.

### FIELD

The present disclosure relates to an internal combustion engine for a motor vehicle, in particular for an automobile. Furthermore, the disclosure relates to a motor vehicle having such an internal combustion engine.

### BACKGROUND

A vehicle can be taken as known from EP 3 020 934 B1, having an internal combustion engine which has a crankcase and a charging device. A crankcase ventilation means is also provided, which has at least one inertia-based oil separator device with at least one inertia-based oil separator, an oil return returning separated oil back to the crankcase, and a suction jet pump, which is driven with compressed air from the charging device and generates a negative pressure in order to drive blow-by-gas. In addition, EP 2 815 089 B1 discloses a vehicle having an internal combustion engine which has a crankcase. Also provided is a crankcase ventilation means, which has at least one oil separator device and an oil return returning separated oil back to the crankcase. Also provided is a conveying device for driving a fluid other than the blow-by-gas. The conveying device is additionally used to drive the blow-by gas in the crankcase ventilation means.

### SUMMARY

One advantage of the present disclosure an internal combustion engine for a motor vehicle and a motor vehicle having such an internal combustion engine, so that particularly advantageous crankcase ventilation can be implemented.

A first aspect of the disclosure relates to an internal combustion engine, also designated an internal combustion machine, motor or combustion motor and preferably designed as a reciprocating piston motor, consequently as a reciprocating piston machine, for a motor of a motor vehicle also simply designated a vehicle. This means that the motor vehicle, preferably formed as an automobile, in particular as a passenger car, in its completely produced state has the internal combustion engine and can be driven by means of the internal combustion engine. The internal combustion engine has a crankcase. For example, the internal combustion engine has an output shaft designed as a crankshaft, which is mounted on the crankcase so as to be rotatable relative to the crankcase about a shaft axis of rotation. Via the crankshaft, the internal combustion engine can provide drive torques for driving the motor vehicle. The internal combustion engine also has an inlet tract through which air can flow, which is also designated an intake tract. The air flowing through the inlet tract is also designated combustion air or fresh air. The internal combustion engine has a tank ventilation means, by means of which a fuel tank can be ventilated. The tank ventilation means is a first ventilation means or is also designated a first ventilation means. In particular, a preferably liquid fuel for operating the internal combustion engine, in particular during its fired operation, is or can be at least temporarily accommodated in the fuel tank. The tank ventilation means has a first suction jet pump, which is also designated a first jet pump or is designed as a first jet pump. To ventilate the fuel tank, at least a first part of the air from the inlet tract can be supplied to the first suction jet pump, so that to ventilate the fuel tank by means of the first suction jet pump by using the air supplied to the first suction jet pump as a propellant for the first section jet pump, a first gas can be sucked out of the fuel tank as a first suction medium. The first gas can, for example, comprise unburned hydrocarbons (HC) which, for example, gas out or can gas out of the fuel that is or can be accommodated in the fuel tank and is preferably liquid. Thus, for example, during operation of the internal combustion engine, the first part of the air from the intake tract is supplied to the suction jet pump, wherein the first part of the air from the intake tract (inlet tract) is used as a first propellant for the first suction jet pump. The first suction jet pump is driven by means of the first propellant in such a way that the first gas is sucked out of the fuel tank by means of the first suction jet pump, using the first propellant and thus by means of the first propellant. This means that the first gas is the first suction medium, which is sucked in by means of the first suction jet pump and with the aid of the first propellant and is thus conveyed out of the fuel tank, whereby the fuel tank is ventilated. The tank ventilation means has a first mixture line through which a first mixture comprising the first suction medium and the first propellant can flow. This means that, during the aforementioned operation, the first propellant and the first suction medium flow through at least part of the first suction jet pump and are mixed and, as a result, form the first mixture, which flows through the first mixture line and in particular is extracted from the suction jet pump by means of the first mixture line.

The internal combustion engine additionally has a crankcase ventilation means, which is also designated as crankcase ventilation. The crankcase ventilation means is a second ventilation means or is also designated a second ventilation means. The crankcase ventilation means has a second suction jet pump, which is also designated a second jet pump or designed as a second suction jet pump. In particular, the second suction jet pump is provided in addition to the first suction jet pump, in particular in such a way that the second suction jet pump is a component that is external with respect to the first suction jet pump and is thus arranged outside the first suction jet pump. Accordingly, provision is preferably made for the first suction jet pump to be a suction jet pump provided in addition to the second suction jet pump, in particular in such a way that the first suction jet pump is a component that is external with respect to the second suction jet pump, consequently is arranged outside the second suction jet pump. The second suction jet pump can be supplied with at least a second part of the air from the inlet tract to ventilate the crankcase, so that to ventilate the crankcase a second gas can be sucked out of the crankcase as a second suction medium by means of the second suction jet pump by using the air supplied to the second suction jet pump as a second propellant for the second suction jet pump. In other words, during the aforementioned operation or else during further operation of the internal combustion engine, the second suction jet pump is supplied with the second part of the air from the inlet tract (intake tract). The second part of the air is used as the second propellant for the second suction jet pump, so that by means of the second suction jet pump by using the second propellant and thus by means of the second propellant, the second gas is sucked out of the crankcase and thus conveyed out of the crankcase, whereby the crankcase is ventilated. The second gas is thus the aforementioned second suction medium which, by means of the second suction jet pump and with the aid of the second propellant, is sucked out of the crankcase and thus conveyed out of the crankcase.

As a result of the ventilation of the fuel tank, which is also designated only as a tank, by means of the ventilation of the crankcase, for example, a respective excess pressure in the crankcase or in the tank can be avoided. The second gas comprises, for example, so-called blow-by-gas which, for example, originates from at least one combustion chamber of the internal combustion engine and flows through between a piston and the corresponding cylinder wall of the internal combustion engine and as a result flows into the crankcase, in particular into a crank chamber of the crankcase. By means of the second suction jet pump and by means of the second propellant, the crankcase, consequently the crank chamber, can be ventilated effectively and efficiently.

The crankcase ventilation means also has a second mixture line, through which a second mixture comprising the second suction medium and the second propellant can flow. This means that the second suction medium and the second propellant flow through at least part of the second suction jet pump, are mixed and form the second mixture as a result, which can flow through the second mixture line and in particular can be extracted from the second suction jet pump by means of the second mixture line. Via or by means of the second mixture line, the second mixture can be introduced into the inlet tract at an introduction point. For this purpose, for example, the second mixture formation at the introduction point is or can be connected fluidically to the inlet tract. For example, the second mixture line opens into the inlet tract at the introduction point. The first mixture line is fluidically connected to the second mixture line at a connection point arranged downstream of the second suction jet pump and upstream of the introduction point and in particular in the second mixture line, so that, for example, the first mixture line opens into the second mixture line at the connection point. At the connection point, the first mixture from the first mixture line can be introduced into the second mixture line. Thus if, for example, in particular in the aforementioned operation, the first mixture from the first mixture line is introduced into the second mixture line at the connection point, then, for example, the first mixture introduced into the second mixture line at the connection point can flow through a length region of the first mixture line of which the length region extends, for example, from the connection point to the introduction point, in particular continuously. Thus, the first mixture can be introduced into the inlet tract at the introduction point, in particular via the length region of the first mixture line. According to the disclosure, the second gas can particularly advantageously be extracted from the crankcase, so that particularly advantageous crankcase ventilation can be implemented. For example, the crankcase ventilation has an oil separator, via which the second suction medium can be supplied to the second suction jet pump. Thus, for example, the second suction jet pump can take in the second suction medium via the oil separator, so that the second suction medium flows through the oil separator on its way from the crankcase to the second suction jet pump. By means of the oil separator, any oil contained in the second gas can be separated from the gas. Most preferably, the oil separator is designed as a particularly purely passive oil separator, by means of which in particular purely passive oil separation can be carried out in order to separate any oil contained in the second suction medium out of the second gas. In particular, the second suction jet pump, the second mixture line and preferably also the oil separator are a constituent part of full-load crankcase ventilation, by means of which the crankcase is or can be ventilated when the internal combustion engine is under full load. Passive crankcase ventilation systems are usual, active crankcase ventilation systems also being known. Both passive crankcase ventilation systems and active crankcase ventilation systems separate any oil contained in the second gas via a pressure drop with corresponding acceleration, in particular of the oil and, for example, of the second gas, wherein, for example, heavy droplets of the oil are usually separated from a main flow of the second gas by centrifugal force and are separated from the second gas as a result. A level of separation that can be implemented by means of the oil separator is usually based on the pressure drop and, as a result, can be undesirably limited. As a result, in particular under full load of the internal combustion engine, an undesirably high residual oil content, consequently an undesirably high quantity of unseparated oil, can be contained in the second gas. Unseparated oil in the second gas tends to carbonize and settle on hot components, which can result in an undesired reduction in cross section, consequently an undesired reduction in flow cross sections. According to the disclosure, it is now possible, in particular by means of the second suction jet pump, to generate an additional pressure drop and, in this way, for example to reduce a pressure prevailing in the crankcase as compared with conventional pressures, consequently to implement an advantageously low pressure in the crankcase. This additional reduction of the pressure prevailing in the crankcase which can be effected by the second suction jet pump can be used to establish an advantageously high pressure drop, for example in an oil separator, so that an advantageously high level of separation of the oil separator can be effected. In addition, in the disclosure, the second gas can be sucked effectively and efficiently out of the crankcase.

The feature that the second suction jet pump and the second mixture line and preferably the oil separator are constituent parts of the aforementioned full-load crankcase ventilation, which is also designated full-load ventilation, is in particular to be understood to mean that the second mixture line and the second suction jet pump and preferably also the oil separator are arranged in a so-called full-load path, via which the crankcase is or can be ventilated when the internal combustion engine is under full load. In particular if the oil separator is an in particular purely passive oil separator, a high level of separation of the oil separator can be effected by the use of the second suction jet pump. In particular, pressure losses effected by the, for example, passive oil separator can be compensated. In addition, in the disclosure, particularly advantageous purging, also designated aeration, of the crankcase, in particular of the crank chamber, can be implemented. For this purpose, for example, an air flow also designated as an air stream can be formed as a purge air flow, which, for example, is formed from air originating from the inlet tract, which flows out of the inlet tract via the first suction jet pump and via the first mixture line into the second mixture line at the connection point and then, for example, flows through a second length region of the second mixture line, the second length region of which extends from the connection point to the second suction jet pump, in particular continuously and thus without interruption. The purge air flow, consequently the air forming the purge air flow and originating from the intake tract can, for example, thus flow via the second length region of the second mixture line to the second suction jet pump and then flow through the second suction jet pump, in particular in a flow direction which is opposite to a further flow direction, in which, for example, the second suction medium and/or the second propellant flows through the second jet pump when the crankcase is ventilated by means of the second suction jet pump. The purge air flow and thus the air forming the purge air flow can thus flow through the second suction jet pump and from the second suction jet pump can flow into the crankcase, whereby the crankcase is purged, consequently aerated. For example, the second suction medium can be supplied to the second suction jet pump via a suction line which, for example, is fluidically connected to the crankcase, in particular to the crank chamber, and is or can be fluidically connected to the second suction jet pump, so that the second suction medium from the crankcase can be introduced into the suction line and fed by means of the suction line to the second suction jet pump, which can thus be supplied with the second suction medium from the crankcase via the second suction line. Thus, for example, the purge air flow, consequently the air forming the purge air flow, from the second suction jet pump can flow through the suction line, in particular in a flow direction which is opposite to a flow direction in which the second suction medium flows through the suction line, when the crankcase is ventilated by means of the second suction jet pump.

The purge air flow can flow through the suction line and, as a result, flow from the second suction jet pump via the suction line into the crankcase, consequently be introduced into the crankcase by means of the suction line from the suction jet pump, whereby the crankcase can advantageously be purged. In particular, the purge air flow can be formed under partial load, i.e. in partial-load operation of the internal combustion engine and/or when the internal combustion engine is operated in a non-charged characteristic map area, i.e. when the internal combustion engine is operated in an area of its characteristic map wherein, in the area, in particular active charging of the internal combustion engine by means of a compressor arranged in the intake tract, for example, is suppressed. Alternatively or additionally, for example, a purge air flow from the inlet tract can be formed, which flows through a propellant line, by means of which the second suction jet pump can be supplied with the second propellant, and is thus led by means of the propellant line to the second suction jet pump, then flows through the second suction jet pump and then the suction line, and thus flows into the crankcase via the propellant line, the second suction jet pump and the suction line. In this way, the crankcase can advantageously be purged, i.e. aerated. It is thus possible, for example, to dispense with an additional purging or aeration line. As a result of purging the crankcase, for example, the crankcase can be dried and/or advantageously fuel can be extracted from the crankcase. Since the air forming the purge air flow originates from the inlet tract, the air forming the purge air flow is fresh air, whereby the crankcase can particularly advantageously be purged.

In order to be able to implement particularly advantageous ventilation of the crankcase, in particular under full load of the internal combustion engine, a check valve is provided in an advantageous embodiment of the disclosure, which is arranged in the second mixture line downstream of the connection point and, in particular automatically, opens in the direction of the inlet tract and closes in the direction of the connection point. The feature that the check valve is arranged downstream of the connection point is to be understood to mean that the check valve is arranged downstream of the connection point in relation to a first flow direction, whereby when the crankcase is ventilated by means of the second suction jet pump, the second mixture flows through the first mixture line in the first flow direction. The check valve thus opens, in particular automatically, in the first flow direction, and the check valve thus closes or blocks, in particular automatically, in a flow direction opposite to the first flow direction. The check valve thus, in particular automatically, opens the mixture line for a fluid flow flowing through the mixture line in the first flow direction and thus via the mixture line into the inlet tract at the introduction point, whereby, in particular when the internal combustion engine is under full load, the crankcase can advantageously be ventilated. For an opposite fluid flow flowing through the second mixture line in the second flow direction from the introduction point via the check valve, the check valve blocks the second mixture line, in particular automatically, so that an undesired flow, in particular reverse flow, of a fluid from the inlet tract in the direction of the second suction jet pump and in the direction of the connection point can be avoided. In particular, the fluid can be, for example, the air flowing through the intake tract (inlet tract).

A further embodiment is distinguished by the fact that the inlet tract has a supply point. At the first supply point, the first part of the air flowing through the inlet tract can be branched off from the inlet tract and supplied to the first suction jet pump as the first propellant. In other words, for example during the aforementioned operation, the first part of the air flowing through the inlet tract is branched off from the inlet tract at the supply point and supplied to the first suction jet pump. Alternatively or additionally, the second part of the air flowing through the inlet tract can be branched off from the inlet tract at the supply point and supplied to the second suction jet pump as the second propellant. Thus, for example during the aforementioned operation or during the aforementioned further operation, the second part of the air flowing through the inlet tract can be branched off from the inlet tract at the supply point and supplied to the second suction jet pump.

It is been shown to be particularly advantageous if the supply point is arranged downstream of a throttle flap arranged in the inlet tract, by means of which a volume of the air flowing through the inlet tract that is to be supplied to the aforementioned combustion chamber of the internal combustion engine can be adjusted. In this way, for example, the crankcase can advantageously be ventilated.

Alternatively, it has been shown to be particularly advantageous if the supply point is arranged upstream of the throttle flap arranged in the inlet tract. In this way, the aforementioned purge air flow can advantageously be formed, for example, so that particularly advantageous purging of the crankcase can be effected in a simple, cost-effective manner that is beneficial to installation space and weight.

The feature that the supply point is arranged downstream or upstream of the throttle flap is to be understood to mean that the supply point is arranged upstream or downstream of the throttle flap in particular in the inlet tract in relation to an air flow direction, wherein the air can flow or flows through the inlet tract in the air flow direction in order to supply the air to the combustion chamber of the internal combustion engine as a result.

It has been shown to be particularly advantageous if the first ventilation means has a first supply line that is connected fluidically to the first suction jet pump and fluidically to the inlet tract at a first branch point, by means of which at least part of the air flowing through the inlet tract can be branched off from the inlet tract at the first branch point and introduced into the first supply line as supply air. This means that the part of the air flowing through the inlet tract is designated supply air, wherein the part of the air flowing through the inlet tract is branched off from the inlet tract at the first branch point, in particular during the aforementioned operation, and is introduced into the supply line. The supply air, consequently the part of the air flowing through the inlet tract branched off from the inlet tract at the first branch point and introduced into the first supply line, can flow through the first supply line. A second supply line is provided, which is connected fluidically to the first supply line at a branch point downstream of the first branch point and upstream of the first suction jet pump and thus branches off from the first supply line at the second branch point. The feature that the second branch point is arranged downstream of the first branch point and upstream of the first suction jet pump is to be understood to mean that the second branch point is arranged downstream of the first branch point and upstream of the first suction jet pump relative to a propellant flow direction, wherein the first propellant flows or can flow through the first supply line in the propellant flow direction in order to supply the first suction jet pump with the first suction medium as a result. By means of the second supply line, while leaving a first part of the supply air in the first supply line, a second part of the supply air can be branched off from the first supply line at the second branch point and introduced into the second supply line as the second propellant. In other words, for example during the aforementioned operation, the aforementioned second part of the supply air is branched off from the first supply line at the second branch point by means of the second supply line and introduced into the second supply line, wherein the second part of the supply air that is branched off is used as the second propellant and supplied to the second suction jet pump. However, not all of the supply air from the first supply line is branched off, instead the aforementioned first part of the supply air is left in the first supply line. By means of the second supply line, the second propellant can be supplied to the second suction jet pump. By means of the first supply line, the first part of the supply air left or remaining in the first supply line is or can be supplied to the second suction jet pump as the propellant. Thus, a particularly advantageous supply of the suction jet pumps with the propellants can be implemented in a manner that is beneficial in terms of installation space and costs, so that both particularly advantageous ventilation of the fuel tank and also particularly advantageous ventilation of the crankcase can be effected.

It has been shown to be particularly advantageous if the supply point is the first branch point and, as a result, a supply point that is common to the suction jet pumps, via which the suction jet pumps can be supplied with propellant from the inlet tract. As a result, both advantageous ventilation of the fuel tank and also particularly advantageous ventilation of the crankcase can be implemented in a simple, cost-effective manner.

A further embodiment is distinguished by the fact that a pressure sensor, by means of which a pressure prevailing in the second supply line can be detected, is arranged in the second supply line, upstream of the second suction jet pump and downstream of the second branch point. This is to be understood in particular to mean that the pressure sensor is arranged upstream of the second suction jet pump and downstream of the second branch point in the second supply line in relation to a second propellant flow direction, wherein the second propellant flows or can flow through the second supply line in the second propellant flow direction in order to supply the second suction jet pump with the second propellant.

A second aspect of the disclosure relates to an internal combustion engine, also designated an internal combustion machine, motor or internal combustion motor and preferably designed as a reciprocating piston motor, consequently as a reciprocating piston machine, for a motor vehicle simply also designated a vehicle. The internal combustion engine according to the second aspect of the disclosure has a crankcase and an inlet tract through which air can flow, which is also designated an intake tract. Furthermore, the internal combustion engine according to the second aspect of the disclosure has a throttle flap arranged in the inlet tract, by means of which a volume of the air flowing through the inlet tract, also designated combustion air or fresh air, to be supplied to at least one combustion chamber of the internal combustion engine can be adjusted. The internal combustion engine according to the second aspect of the disclosure additionally has a crankcase ventilation means, which also has a suction jet pump designated a jet pump. To ventilate the crankcase, at least part of the air from the inlet tract can be supplied to the suction jet pump, so that a gas can be sucked out of the crankcase as a suction medium in order to ventilate the crankcase by means of the suction jet pump by using the air supplied to the suction jet pump as a propellant for the suction jet pump.

In order to be able to implement particularly advantageous ventilation of the crankcase, in particular when the internal combustion engine is under full load, in the second aspect of the disclosure provision is made for the supply point at which at least the part of the air can be branched off from the inlet tract as the propellant, flowing through the inlet tract in the flow direction and in particular flowing to the combustion chamber, to be arranged downstream of the throttle flap. Advantages and advantageous embodiments of the first aspect of the disclosure are to be viewed as advantages and advantageous embodiments of the second aspect of the disclosure and vice versa.

A third aspect of the disclosure relates to a motor vehicle, simply also designated a vehicle and preferably designed as an automobile, in particular a passenger car, which has an internal combustion engine according to the first aspect or according to the second aspect of the disclosure and can be driven by means of the internal combustion engine. Advantages and advantageous embodiments of the first aspect and of the second aspect of the disclosure are to be viewed as advantages and advantageous embodiments of the third aspect of the disclosure and vice versa.

### BRIEF DESCRIPTION OF THE DRAWINGS

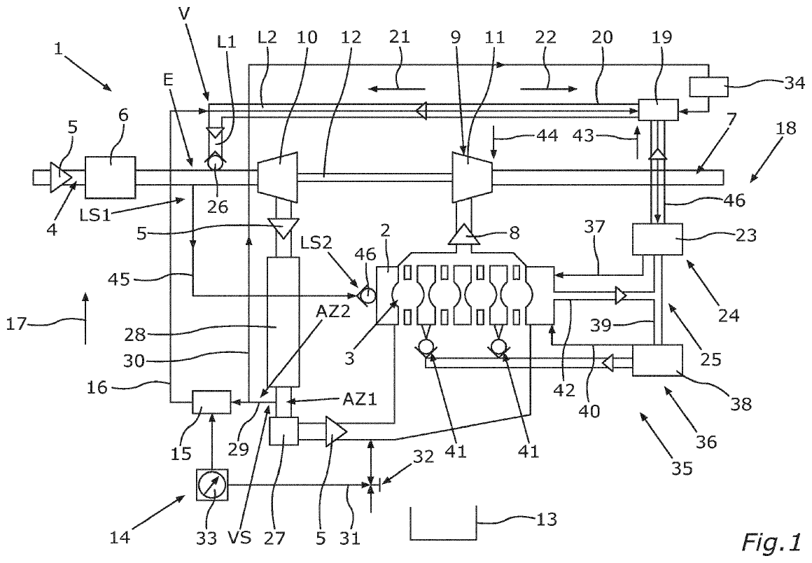

Further details of the disclosure can be gathered from the following description of a preferred exemplary embodiment together with the associated drawing. The single FIG. 1 shows a schematic representation of an internal combustion engine for a motor vehicle.

### DESCRIPTION

FIG. 1 shows a schematic representation of an internal combustion engine 1, also designated an internal combustion machine, motor or combustion motor and preferably as a reciprocating piston motor, consequently as a reciprocating piston machine, for a motor vehicle also simply designated a vehicle. The internal combustion engine 1 has a crankcase 2, by which, for example, a number of cylinders 3 of the internal combustion engine 1 are formed. Thus, for example, the crankcase 2 is formed as a cylinder crankcase. A respective combustion chamber of the internal combustion engine 1 is partly formed by the respective cylinder 3. The internal combustion engine 1 additionally has an inlet tract 4, also designated an intake tract, through which air, also designated fresh air or combustion air, flows. By means of the inlet tract 4, the air flowing through the inlet tract 4 can be led to and into the combustion chambers. In FIG. 1, a first flow direction, which is also designated as an air flow direction, is illustrated by arrows 5. The air flows or can flow through the inlet tract 4 in the air flow direction in order, as a result, to conduct the air to and into the combustion chambers. In other words, the air flows through the inlet tract 4 in the air flow direction on its way through the inlet tract 4 to and into the combustion chambers.

Arranged in the inlet tract 4 is an air filter 6, by means of which the air flowing through the inlet tract 4 is filtered. The internal combustion engine 1 additionally has an exhaust gas tract 7, through which exhaust gas from the combustion chambers can flow. In FIG. 1, an arrow 8 illustrates a second flow direction, in which the exhaust gas from the combustion chambers flows or can flow through the exhaust gas tract 7, whereby the exhaust gas can be extracted from the combustion chambers. The internal combustion engine 1 in the exemplary embodiment shown in FIG. 1 has an exhaust gas turbocharger 9, which has a compressor 10 arranged in the inlet tract 4 and a turbine 11 arranged in the exhaust gas tract 7. The turbine 11 can be driven by the exhaust gas flowing through the exhaust gas tract 7. The turbine 11 can drive the compressor 10 via a shaft 12 of the exhaust gas turbocharger 9, wherein by driving the compressor 10, the air flowing through the inlet tract 4 can be compressed by means of the compressor 10, consequently charged. Thus, the combustion chambers of the internal combustion engine 1 can be supplied with the air compressed by means of the compressor 10, which is also designated charging up or charging the internal combustion engine 1. For example, the internal combustion engine 1 is operated with charging in a first area of its characteristic map, so that in the first area of the characteristic map, also designated a first characteristic map area, the internal combustion engine 1 is operated in non-charged operation. The second area of the characteristic map is also designated a second characteristic map area or non-charged characteristic map area. In the second area of the characteristic map, for example, supplying the combustion chambers with air compressed by means of the compressor 10 is suppressed, wherein the combustion chambers are supplied with the air from the inlet tract 4 but the air with which the combustion chambers are supplied is not charged by means of the compressor 10. For example, the first area of the characteristic map is or comprises a full load, i.e. full-load operation of the internal combustion engine 1. It is also conceivable that the second area of the characteristic map is or comprises a partial load, consequently a partial-load operation of the internal combustion engine 1.

In its fired operation, the internal combustion engine 1 can be operated by means of a preferably liquid fuel. In the fired operation, within a respective working cycle of the internal combustion engine 1, a fuel-air mixture is burned in the respective combustion chamber, which results in the exhaust gas. The fuel-air mixture comprises the preferably liquid or else gaseous fuel and the air from the inlet tract 4. The internal combustion engine 1 has a fuel tank 13, illustrated particularly schematically in FIG. 1 and also simply designated a tank, in which the fuel is or can be at least temporarily accommodated. The internal combustion engine 1 has a tank ventilation means 14 provided or designed to ventilate the fuel tank 13, which may also be referred to herein as a “tank ventilation arrangement” and is also designated a first aeration device. The tank ventilation means 14 has a first suction jet pump 15, which is also designated a first jet pump. The first suction jet pump 15 can be supplied with at least a first part of the air from the inlet tract to ventilate the fuel tank 13, so that a first gas can be sucked in from the fuel tank 13 as a first suction medium and thus conveyed out of the fuel tank 13 by means of the first section jet pump 15 by using the air supplied to the first suction jet pump 15 as a first propellant for the first suction jet pump 15 to ventilate the fuel tank 13. The tank ventilation means 14 has a first mixture line 16, through which a first mixture comprising the first suction medium and the first propellant can flow. In FIG. 1, an arrow 17 designates a third flow direction in which the first mixture flows through the mixture line 16, in order in this way to extract the first mixture from the suction jet pump 15.

The internal combustion engine 1 further has a crankcase ventilation means 18, which is also designated a second ventilation means. The crankcase ventilation means 18 has a second suction jet pump 19, also designated a second jet pump, to which a second part of the air from the inlet tract 4 can be supplied to ventilate the crankcase 2, so that a second gas can be sucked out of the crankcase 2 as a second suction medium and thus conveyed out of the crankcase 2 by means of the second suction jet pump 19 by using the air supplied to the second suction jet pump 19 as a propellant for the second suction jet pump 19. The crankcase ventilation means 18 has a second mixture line 20, through which a second mixture comprising the second suction medium and the second propellant can flow. In FIG. 1, an arrow 21 designates a fourth flow direction, in which the second mixture flows through the second mixture line 20 in order in this way to carry the second mixture away from the suction jet pump 19. A fifth flow direction, opposite to the fourth flow direction, is illustrated by an arrow 22. Via or by means of the second mixture line 20, the second mixture can be introduced into the inlet tract 4 at an introduction point E. For this purpose, the mixture line 20 is fluidically connected to the inlet tract 4 at the introduction point E. The first mixture line 16 is fluidically connected to the second mixture line 20 at a connection point V which, in relation to the fourth direction illustrated by the arrow 21, is arranged upstream of the introduction point E and downstream of the second suction jet pump 19, in particular in the second mixture line 20. At the connection point V, the first mixture can be led out of the first mixture line 16 and introduced into the second mixture line 20. FIG. 1 reveals that the second mixture line 20 has a first length region L1 which extends from the connection point V to the introduction point E, in particular continuously and thus without interruption. L2 designates a second length region of the mixture line 20. The second length region L2 extends from the connection point V, in particular continuously and thus without interruption, to the suction jet pump 19 and vice versa, so that, in relation to the fourth flow direction illustrated by the arrow 21, the second length region L2 is arranged upstream of the first length region L1. The length regions L1 and L2 are connected fluidically to each other, wherein, for example, the length region L2 merges directly into the length region L1 and vice versa.

The crankcase ventilation means 18 additionally comprises an oil separator 23, which is preferably designed as an in particular purely passive oil separator, by means of which any oil contained in the second gas can be separated, in particular purely passively, from the gas. In the present case, the suction jet pump 19, the mixture line 20 and also the oil separator 23 are constituent parts of full-load crankcase ventilation 24, by means of which the crankcase 2 is or can be ventilated at full load, i.e. in full-load operation, of the internal combustion engine 1. The suction jet pump 19, the mixture line 20 and in the present case also the oil separator 23 are thus in a full-load path 25 of the crankcase ventilation means 18, in particular the full-load crankcase ventilation 24, wherein the second gas is or can be extracted from the crankcase 2 via the full-load path 25, in particular in full-load operation of the internal combustion engine 1. If, in particular in full-load operation of the internal combustion engine 1, the crankcase 2 is ventilated via the full-load path 25 by means of the suction jet pump 19, then the second gas flows out of the crankcase 2 in the fourth flow direction illustrated by the arrow 21, through the full-load path 25 and thus through the oil separator 23, the suction jet pump 19 and the mixture line 20. Relative to the fourth flow direction, the oil separator 23 is arranged upstream of the suction jet pump 19 which, for example, is arranged upstream of at least part of the mixture line 20. By means of the suction jet pump 19, a particularly advantageous pressure ratio can be implemented, by means of which the crankcase 2 can particularly advantageously be ventilated and, in particular, a particularly high level of separation of the oil separator 23 can be implemented. In addition, for example at full load, i.e. in the full-load operation of the internal combustion engine 1, an advantageous purge air flow can be established, which is formed by air from the inlet tract 4. This purge air flow will be explained in more detail below.

In the exemplary embodiment shown in FIG. 1, the internal combustion engine 1 has a check valve 26 which, in relation to the fourth flow direction illustrated by the arrow 21, is arranged in the second mixture line 20 downstream of the connection point V and automatically opens in the direction of the inlet tract 4 and closes in the direction of the connection point V. As a result, for example, the second mixture can flow into the mixture line 20 and the check valve 26 in the fourth flow direction and thus flow into the inlet tract 4 at the introduction point E. However, in the fifth flow direction illustrated by the arrow 22 and opposite to the fourth flow direction, the check valve 26 automatically closes and thus blocks the mixture line 20 to a flow coming from the inlet tract 4 and flowing in the direction of the connection point V, so that, for example, a reverse flow of air from the inlet tract 4 to the connection point V via the check valve 26 can be avoided. For example, in relation to the fourth flow direction illustrated by the arrow 21, the check valve 26 is arranged upstream of the introduction point E and downstream of the connection point V, or the check valve 26 is arranged at the introduction point E and thus downstream of the connection point V.

The inlet tract 4 has a supply point VS, at which both the first part of the air flowing through the inlet tract 4 can be branched off from the inlet tract 4 and supplied to the first suction jet pump 15 as the first propellant, and also the second part of the air flowing through the inlet tract 4 can be branched off from the inlet tract 4 and supplied to the second suction jet pump 19 as the second propellant.

Arranged in the inlet tract 4 is a throttle flap 27, by means of which a volume of the air flowing through the inlet tract 4 and to be supplied to the combustion chambers of the internal combustion engine 1 can be adjusted. Furthermore, an intercooler 28 is arranged in the inlet tract 4, being arranged downstream of the compressor 10 and downstream of the throttle flap 27. By means of the intercooler 28, the air compressed by means of the compressor 10 and heated as a result can be cooled. In the exemplary embodiment shown in FIG. 1, the supply point VS is arranged upstream of the throttle flap 27 and downstream of the compressor 10 in the flow direction of the air flowing through the inlet tract 4 and flowing to the combustion chambers and, in the present case, downstream of the intercooler 28. The respective propellant can thus be air originating from the inlet tract 4 and compressed by the compressor 10.

The internal combustion engine 1 has a first supply line 29, which is fluidically connected to the inlet tract 4 at a first branch point AZ1. By means of the supply line 29, at least part of the air flowing through the inlet tract 4 is branched off from the inlet tract 4 at the first branch point AZ1 and introduced into the first supply line 29, wherein the part of the air branched off from the inlet tract 4 at the branch point AZ1 and flowing through the inlet tract 4 and introduced into the supply line 29 is also designated supply air. The internal combustion engine 1 also has a second supply line 30, which is fluidically connected to the first supply line 29 at a second branch point AZ2. In the flow direction of the supply air flowing through the supply line 29 and flowing from the branch point AZ1 in the direction of the suction jet pump 15, the branch point AZ2 is arranged downstream of the branch point AZ1 and upstream of the suction jet pump 15. By means of the supply line 30, a first part of the supply air is left in the supply line 29, and a second part of the supply air is branched out of the supply line 29 at the second branch point AZ2 and introduced into the supply line 30 and led to the suction jet pump 19 by means of the supply line 30, so that the second part of the supply air branched off from the supply line 29 at the branch point AZ2 is used as the second propellant for the suction jet pump 19. Thus, the second part of the supply air is the previously mentioned, second part of the air from the inlet tract 4 used as the second propellant. The first part of the supply air left and consequently remaining in the supply line 29 is led to the suction jet pump 15 by means of the supply line 29 and used as the first propellant for the suction jet pump 15. Thus, the first part of the supply air is the previously mentioned first part of the air from the inlet tract 4 used as the first propellant. It can be seen that the supply point VS is the first branch point AZ1, so that both suction jet pumps 15 and 19 are or can be supplied with the propellants via the supply point VS or branch point AZ1 common to the suction jet pumps 15 and 19.

The supply line 29 is, for example, also designated a first propellant line, since the suction jet pump 15 is supplied with the first propellant via the supply line 29. The second supply line 30 is, for example, also designated a second propellant line, since the suction jet pump 19 is or can be supplied with the second propellant via the supply line 30. In FIG. 1, a first suction line is designated by 31. The first suction line 31 is, for example, a constituent part of the tank ventilation means 14. Via the first suction line 31, the first suction medium from the fuel tank 13 can be supplied to the suction jet pump 15, in particular via a tank ventilation valve 32 of the tank ventilation means 14. For example, the tank ventilation valve 32 is arranged in the suction line 31. For example, a pressure sensor 33 of the tank ventilation means 14 can be arranged in the suction line 31, in particular in such a way that, in the flow direction of the first suction medium flowing through the suction line 31 and in particular flowing from the fuel tank 13 to the suction jet pump 15, the pressure sensor 33 is arranged upstream of the suction jet pump 15 and downstream of the fuel tank 13. By means of the pressure sensor 33, a pressure prevailing in the suction line 31 can be detected. For example, a pressure sensor 34 in particular illustrated schematically in FIG. 1 is arranged in the supply line 30, in particular in such a way that, in the flow direction of the second propellant flowing through the supply line 30 and flowing toward the suction jet pump 19, the pressure sensor 34 is arranged upstream of the suction jet pump 19 and in particular downstream of the branch point AZ2. A pressure prevailing in the supply line 30 can be detected by means of the pressure sensor 34. The pressure sensor 34 is arranged particularly close to the suction jet pump 19.

In the exemplary embodiment shown in FIG. 1, the crankcase ventilation means 18 has partial-load crankcase ventilation 35, in particular provided in addition to the full-load crankcase ventilation 24, by means of which the crankcase 2 is or can be ventilated under partial load, i.e. in the partial-load operation of the internal combustion engine 1. The partial-load crankcase ventilation 35 has a partial-load path 36, via which the crankcase 2 is ventilated in the partial-load operation of the internal combustion engine 1.

The crankcase ventilation means 18 has a second suction line 46, via which the second gas from the crankcase 2 can be supplied to the suction jet pump 19. In other words, the suction jet pump 19 takes the second gas in from the crankcase 2 via the second suction line 46, in particular when the crankcase 2 is ventilated by means of the crankcase ventilation means 18, in particular by means of the full-load crankcase ventilation 24, in particular in full-load operation of the internal combustion engine 1. If the crankcase 2 is ventilated by means of the full-load crankcase ventilation 24 and in full-load operation of the internal combustion engine 1, then the second suction medium flows in the fourth flow direction, illustrated by the arrow 21, through the full-load path 25 and thus through the suction line 46. In relation to the second flow direction of the second gas illustrated by the arrow 21, the oil separator 23 is arranged in the suction line 46 upstream of the suction jet pump 19 and, for example, downstream of the crankcase 2, so that the second suction medium flows through the oil separator 23 on its way from the crankcase 2 to the suction jet pump 19. The oil separator 23 is also designated a full-load separator (VLA). The first return line is designated by 37. Via the first return line 37, the oil separated from the second gas by means of the oil separator 23 can, for example, be led back into the crankcase 2 and/or into a sump of the internal combustion engine 1.

It can be seen that the full-load path 25 comprises the suction line 46 and thus the oil separator 23, the suction jet pump 19 and the mixture line 20. The partial-load crankcase ventilation 35 has a ventilation line 39, so that the partial-load path 36 comprises the ventilation line 39. Via the ventilation line 39, in particular in partial-load operation of the internal combustion engine 1, the second gas or gas can be led out of the crankcase 2, wherein a further oil separator 38 provided in particular in addition to the oil separator 23 is arranged in the ventilation line 39. The oil separator 38 is thus a partial-load separator (TLA), by means of which, in particular when the internal combustion engine 1 is under partial load, any oil contained in the gas flowing in the second or third ventilation line 39 or the partial-load path 36 is separated. A second return line 40 is provided, by means of which the oil separated by means of the oil separator 38 is extracted from the oil separator 38 and, for example, led into the crankcase 2 and/or into the sump and/or into a cylinder head of the internal combustion engine 1, in particular can be returned. Downstream of the oil separator 38, the ventilation line 39 or the partial-load path 36 can introduce the cleaned gas, in particular via check valves 41, into the inlet tract 4 and/or directly into the combustion chambers, in particular at a point arranged downstream of the throttle flap 27. It can be seen that the suction line 46 and the ventilation line 39 and thus the full-load path 25 and the partial-load path 36 have a common line part 42, via which gas from the crankcase 2 can be led away both when the crankcase 2 is ventilated by means of the full-load crankcase ventilation 24 in full-load operation of the internal combustion engine 1, and also when the crankcase 2 is ventilated by means of the partial-load crankcase ventilation 35 in partial-load operation of the internal combustion engine 1.

The aforementioned purge air flow is described below. The purge air can be formed or established in particular under partial load, i.e. in partial-load operation, of the internal combustion engine 1, being formed by air from the inlet tract 4 and flowing or led to the suction jet pump 19 from the supply point VS or from the branch point AZ1 via the supply line 29, the suction jet pump 15, the mixture line 16 and the length region L2. The purge air flow is thus extracted from the mixture line 16 at the connection point V and introduced into the length region L2 and can flow through the length region L2 in the fifth flow direction opposite to the fourth flow direction, illustrated by the arrow 22, and thus flow to the suction jet pump 19.

In FIG. 1, a sixth flow direction is illustrated by an arrow 43, in which the second suction medium flows through the suction line 46 and the oil separator 23 on its way from the crankcase 2 to the suction jet pump 19. A seventh flow direction, opposite to the sixth flow direction, is illustrated by an arrow 44. The aforementioned purge air flow can flow through at least part of the suction line 46 from the suction jet pump 19 in the seventh flow direction illustrated by the arrow 44, and thus flow to the oil separator 23 via the part of the suction line 46. From the oil separator 23, for example, the purge air flow can flow through the return line 37 and flow into the crankcase 2 via the return line 37. It can be seen that the purge air flow is or can thus be introduced into the crankcase 2 via the supply line 29, the suction jet pump 15, the mixture line 16, the length region L2, the suction jet pump 19, at least the part of the suction line 46 and the oil separator 23 and, in the present case, the return line 37, whereby the crankcase 2 can be purged, consequently aerated. It is thus possible, for example, to dispense with an additional purge air line for purging the crankcase 2.

In the exemplary embodiment shown in FIG. 1, however, an additional purge air line is shown by way of example and designated by 45. The purge air line 45 is fluidically connected to the inlet tract 4 at a first purge air point LS1 and connected fluidically to the crankcase 2 at a second purge air point LS2. In the exemplary embodiment shown in FIG. 1, the purge air point LS1 is arranged upstream of the compressor 10 in the flow direction of the air flowing through the inlet tract 4 and toward the combustion chambers and, in the present case, downstream of the air filter 6 and in the present case also upstream of the introduction point E. For example, a check valve 47 is arranged in the purge air line 45. By means of the purge air line 45, at least part of the air flowing through the inlet tract 4 can be branched off from the inlet tract 4 at the purge air point LS1 and introduced into the purge air line 45 as purge air. The purge air introduced into the purge air line 45 can be introduced into the crankcase 2 by means of the purge air line 45 and via the check valve 47, whereby the crankcase 2 can be aerated, consequently flushed. Thus, provision is preferably made for the check valve 47 to open, in particular automatically, in the direction of the crankcase 2 and, to close, in particular automatically, in the opposite direction, consequently in the direction of the purge air point LS1.

In principle, it would be conceivable for the supply point VS or the branch point AZ1 to be arranged in the inlet tract 4 downstream of the throttle flap 27 and in particular upstream the combustion chambers.

### List of Designations

1 Internal combustion engine
2 Crankcase
3 Cylinder
4 Inlet tract
5 Arrow
6 Air filter
7 Exhaust gas tract
8 Arrow
9 Exhaust-gas turbocharger
10 Compressor
11 Turbine
12 Shaft
13 Fuel tank
14 Tank ventilation means
15 First suction jet pump
16 First mixture line
17 Arrow
18 Crankcase ventilation means
19 Second suction jet pump
20 Second mixture line
21 Arrow
22 Arrow
23 Oil separator
24 Full-load crankcase ventilation
25 Full-load path
26 Check valve
27 Throttle flap
28 Intercooler
29 First supply line
30 Second supply line
31 First suction line
32 Tank ventilation valve
33 Pressure sensor
34 Pressure sensor
35 Partial-load crankcase ventilation
36 Partial-load path
37 Return line
38 Oil separator
39 Ventilation line
40 Return line
41 Check valve
42 Line part
43 Arrow
44 Arrow
45 Purge air line
46 Second suction line
47 Check valve
E Introduction point
V Connection point
L1 First length region
L2 Second length region
LS1 Purge air point
LS2 Purge air point
AZ1 Branch point
AZ2 Branch point
VS Supply point

1 -10. (canceled).

11. An internal combustion engine for a motor vehicle, the internal combustion engine comprising:
a crankcase;
an inlet tract through which air can flow;
a tank ventilation arrangement configured to ventilate a fuel tank, the tank ventilation arrangement comprising:
a first suction jet pump to which a first part of the air from the inlet tract is supplied to ventilate the fuel tank, wherein to ventilate the fuel tank, a first gas is sucked out of the fuel tank as first suction medium by means of the first suction jet pump by using the air supplied from the first suction jet pump as a first propellant for the first suction jet pump; and
a first mixture line, wherein a first mixture comprising the first suction medium and the first propellant is configured to flow through the first mixture line; and
a crankcase ventilation arrangement comprising:
a second suction jet pump to which at least a second part of the air from the inlet tract is supplied, wherein to ventilate the crankcase, a second gas is sucked out of the crankcase as a second suction medium by means of the second suction jet pump by using the air supplied to the second suction jet pump as a second propellant for the second suction jet pump; and
a second mixture line, wherein a second mixture comprising the second suction medium and the second propellant is configured to flow through the second mixture line, via which the second mixture can be introduced into the inlet tract at an introduction point, wherein the first mixture line is connected fluidically to the second mixture line at a connection point arranged downstream of the second suction jet pump and upstream of the introduction point at which the first mixture from the first mixture line is introduced into the second mixture line.

12. The internal combustion engine as claimed in claim 11, further comprising:
a check valve arranged in the second mixture line downstream of the connection point, wherein the check valve is configured to open in a direction of the inlet tract and close in the direction of the connection point.

13. The internal combustion engine as claimed in claim 12, wherein the inlet tract has a supply point at which:
the first part of the air flowing through the inlet tract is branched off from the inlet tract and supplied to the first suction jet pump as the first propellant; and/or
the second part of the air flowing through the inlet tract is branched off from the inlet tract and supplied to the second suction jet pump as the second propellant.

14. The internal combustion engine as claimed in claim 13, wherein the supply point is arranged downstream of a throttle flap arranged in the inlet tract.

15. The internal combustion engine as claimed in claim 13, wherein the supply point is arranged upstream of a throttle flap arranged in the inlet tract.

16. The internal combustion engine as claimed in claim 13 further comprising:
a first supply line connected fluidically to the first suction jet pump and fluidically to the inlet tract at a first branch point, wherein at least a part of the air flowing through the inlet tract is branched off from the inlet tract at the first branch point and introduced into the first supply line as supply air; and
a second supply line connected fluidically to the first supply line at a second branch point arranged downstream of the first branch point and upstream of the first suction jet pump, wherein, while leaving a first part of the supply air in the first supply line, a second part of the supply air is branched off from the first supply line at the second branch point and introduced into the second supply line as the second propellant, wherein the second propellant is supplied to the second suction jet pump, wherein the first part of the supply air left in the first supply line is supplied to the first suction jet pump as the first propellant by the first supply line.

17. The internal combustion engine as claimed in claim 15, wherein the supply point is a supply point common to a first branch point and, as a result, to one of the suction jet pumps, via which the suction jet pumps are supplied with the propellants from the inlet tract.

18. The internal combustion engine as claimed in claim 17, further comprising a pressure sensor, wherein the pressure sensor is configured to detect a pressure prevailing in the second supply line, the pressure sensor arranged in the second supply line, upstream of the second suction jet pump and downstream of a second branch point.

19. A motor vehicle having an internal combustion engine as claimed in claim 11.

20. An internal combustion engine for a motor vehicle, the internal combustion engine comprising:
a crankcase,
an inlet tract through which air can flow,
a throttle flap arranged in the inlet tract and configured to adjust a volume of the air supplied to at least one combustion chamber of the internal combustion engine, and
a crankcase ventilation means including a suction jet pump to which at least a part of the air from the inlet tract is supplied to ventilate the crankcase, wherein to ventilate the crankcase, a gas is sucked out of the crankcase as a suction medium by means of the suction jet pump by using the air supplied from the suction jet pump as a propellant for the suction jet pump, wherein at which at least the part of the air is branched off from the inlet tract as the propellant at a supply point, and wherein the supply point is arranged downstream of the throttle flap.

21. A method of ventilating an internal combustion engine including a crankcase, an inlet tract through which air can flow, and a fuel tank, the method comprising:
supplying a first part of the air from the inlet tract to a tank ventilation arrangement including a first suction jet pump;
sucking a first gas out of the fuel tank as first suction medium by means of the first suction jet pump by using the air supplied from the first suction jet pump as a first propellant for the first suction jet pump, wherein a first mixture comprising the first suction medium and the first propellant flows through a first mixture line;
supplying at least a second part of the air from the inlet tract to a second suction jet pump included in a crankcase ventilation arrangement;
sucking a second gas out of the crankcase as a second suction medium by means of the second suction jet pump by using the air supplied to the second suction jet pump as a second propellant for the second suction jet pump, wherein a second mixture comprising the second suction medium and the second propellant flows through a second mixture line; and
introducing the second mixture into the inlet tract at an introduction point via the second mixture line, wherein the first mixture line is connected fluidically to the second mixture line at a connection point arranged downstream of the second suction jet pump and upstream of the introduction point at which the first mixture from the first mixture line is introduced into the second mixture line.

22. The method of claim 21 wherein a check valve is arranged in the second mixture line downstream of the connection point, wherein the check valve is configured to open in a direction of the inlet tract and close in a direction of the connection point.

23. The method of claim 22 wherein the inlet tract has a supply point at which:
the first part of the air flowing through the inlet tract is branched off from the inlet tract and supplied to the first suction jet pump as the first propellant; and/or
the second part of the air flowing through the inlet tract is branched off from the inlet tract and supplied to the second suction jet pump as the second propellant.

24. The method of claim 23 wherein the supply point is arranged downstream of a throttle flap arranged in the inlet tract.

25. The method of claim 23 wherein the supply point is arranged upstream of a throttle flap arranged in the inlet tract.

26. The method of claim 23:
wherein a first supply line is fluidically connected to the first suction jet pump and fluidically connected to the inlet tract at a first branch point, the method further comprising branching off at least a part of the air flowing through the inlet tract from the inlet tract at the first branch point and introducing the at least part of the air into the first supply line as supply air; and
wherein a second supply line is fluidically connected to the first supply line at a second branch point arranged downstream of the first branch point and upstream of the first suction jet pump, the method further comprising, while leaving a first part of the supply air in the first supply line, branching off a second part of the supply air off from the first supply line at the second branch point and introducing the second part of the supply air into the second supply line as the second propellant, wherein the second propellant is supplied to the second suction jet pump, wherein the first part of the supply air left in the first supply line is supplied to the first suction jet pump as the first propellant by the first supply line.

27. The method of claim 26 wherein the supply point is a supply point common to a first branch point and, as a result, to one of the suction jet pumps, via which the suction jet pumps are supplied with the propellants from the inlet tract.

28. The method of claim 27 further comprising detecting a pressure prevailing in the second supply line with a pressure sensor arranged in the second supply line, wherein the pressure sensor is arranged upstream of the second suction jet pump and downstream of a second branch point.

29. The method of claim 21 wherein the internal combustion engine is arranged in a motor vehicle.
